(19) United States
(12) Patent Application Publication
(10) Pub. No.: US 2002/0020489 A1
(43) Pub. Date: Feb. 21, 2002

(54) Device to produce mosaic panels, relative method and mosaic panels thus obtained

(75) Inventors: Giancarlo Bisazza, Vicenza (IT); Aldo Besoli, Montecchio Maggiore (VI) (IT)

Correspondence Address: Finnegan, Henderson, Farabow, Garrett & Dunner, LLP, 1300 I Street, N.W., Washington, DC, 20005-3315, US

(73) Assignee: BISAZZA SpA

(21) Appl. No.: 09/924,972

(22) Filed: Aug. 9, 2001

(30) Foreign Application Priority Data
Aug. 10, 2000 (IT) UD2000A000155

(51) Int. Cl. B32B 31/00

(52) U.S. Cl. 156/269

(57) ABSTRACT

Device and method to produce panels of mosaic tesserae (13), wherein at least a supporting and/or lining sheet (12) is applied on a visible face of the tesserae (13) arranged inside an advancing frame (14); the device comprises feed means (16) and means to apply the sheet (12) cooperating with the feed means of the frame (14), and the application means comprise cutting means (20) able to cut to size a segment (12a) of the sheet (12) and suction drum means (18) able to retain at least temporarily, on their outer cylindrical surface, the segment (12a) of sheet (12) and to release it onto the tesserae (13).

### FIELD OF THE INVENTION

The invention concerns a device and the relative method to produce panels of mosaic tesserae.

To be more exact, the invention concerns a device suitable to apply in line a sheet which can function either as a support or a lining, at least on the visible face of a plurality of tesserae, arranged inside a containing frame advancing on a substantially plane conveyor belt.

The supporting/lining sheet thus applied can be removed when the mosaic panel is applied on a wall which is to be covered or embellished.

The invention also concerns the mosaic panels thus obtained.

### BACKGROUND OF THE INVENTION

In the production of panels made with mosaic tesserae, used to cover walls or floors in general, it is known to produce the individual mosaic tesserae by means of a suitable molding machine starting from a cast of glass material; the individual tesserae are then put into a suitable frame which defines the shape and size of the panel to be obtained.

Normally, the frames are square or rectangular, and have a plurality of seatings, each of which is able to house at least a single tessera.

The panels are then fed to suitable machines which, normally by gluing, apply on said panels a sheet or mesh of plastic or paper material, or of glass fibre, which acts as a support for the tesserae and provides the adequate consistency needed to package, transport, handle and apply the panels.

For example, a conventional method consists of applying a mesh of nylon, glass fibre or similar material on the non-visible face of the tesserae; when the tesserae are laid, the mesh is associated definitively with the surface on which it has to be applied, together with the relative tesserae of the mosaic.

This solution has the advantage that it allows to control the alignment and the quality of the material; however, the supporting mesh can cause pieces of the tesserae to become locally detached and uneven, which in some cases can create problems of an aesthetic nature.

The second type of support used in conventional methods consists of a paper or plastic sheet, not transparent, which is temporarily glued on the visible side of the mosaic tesserae, and then detached therefrom, during the laying stage, after the mosaic tesserae have been glued to the surface on which they can be applied.

In both cases, after the support has been applied, it is necessary to pass the panel inside a drying furnace, in order to dry the glue on the support and make the support stably attached to the tesserae.

Therefore, conventional machines are generally very bulky and need long cycle times to obtain the finished product ready for assembling and packing.

U.S. Pat. No. 5,252,166 and U.S. Pat. No. 5,445,696 teach to apply a transparent adhesive sheet at least on the visible face of a panel of mosaic tesserae to hold them together before assembly.

The present Applicant has devised and embodied this invention to overcome these shortcomings and to obtain further advantages as described hereafter.

### SUMMARY OF THE INVENTION

The invention is set forth and characterized in the respective main claims, while the dependent claims describe other characteristics of the main embodiment.

The purpose of the invention is to achieve a device to produce panels consisting of glass mosaic tesserae which will allow to apply, in stable fashion, a supporting sheet on at least one face of the tesserae, in contained spaces, using limited equipment and in very limited cycle times.

The device according to the invention is applied in cooperation with a substantially linear conveyor belt; the tesserae on which the supporting sheet is to be applied advance on the frames which are suitably distanced from each other; the frames define the shape and size of the panel or tile to be made.

The device comprises means to feed the supporting sheet to be applied, normally consisting of a reel located on a winding shaft, either driven or idle, and means to apply the supporting sheet cooperating with the belt conveying the frames with the tesserae.

According to the invention, the application means consist of shearing means able to cut to size the supporting sheet to be applied, and of at least a suction type drum; the sheet, already cut to size, to be applied to the frame containing the mosaic tesserae, winds on said drum and is at least temporarily held thereon.

The suction drum is provided, on its cylindrical surface, with a plurality of holes through which suction is exerted on the sheet to be applied to the tesserae. In this way the sheet remains adherent to the cylindrical surface of the drum, even after it has been cut by the shearing means.

As it rotates, the drum thus feeds the sheet from the reel from which it is unwound to the mosaic tesserae, eliminating the need to use other drawing means and at the same time keeping the sheet well flattened against its cylindrical surface. The sheet is not therefore subjected to drawing forces which would stretch and damage it.

In a preferential variant, the application means also comprise at least a pressure roller, arranged immediately downstream of the suction drum, which is able to press the supporting sheet against the frame with the tesserae and to achieve a stable attachment.

According to the invention, whether the sheet be of plastic, paper or other suitable material, it has the face which is to be applied to the tesserae already equipped with gluing means.

In the application step the face of the sheet without the glue adheres to the suction drum for an angle sufficient to invert the direction of feed of the sheet, in order to arrange the face which is to couple with the tesserae, and which does have glue, facing said tesserae.

Then the shearing means intervene on the sheet which is partly wound on the suction drum and cut a desired length of sheet to be applied. The segment of sheet is held by the suction drum for the section where the direction is inverted, and then released when it is in a position facing the frame with the tesserae.

To release the segment of sheet, the suction drum has clamping means to block the suction at least for the section of surface of the drum which faces the conveyor belt, and for an amplitude such as to substantially cover the size of the frame containing the tesserae.

The segment of sheet released by the suction drum and resting on the frame advancing on the conveyor belt is then attached stably by means of the pressure exerted by the pressure roller arranged downstream of the suction drum.

In a preferential embodiment, the suction drum is equipped with an alternate vertical movement, performed during the passage of every frame below it, in order to create enough space for the passage thereof without interfering with the suction drum on the conveyor belt.

According to another variant, in the event that the sheet to be applied comprises at least two layers, of which the first is able to be arranged on the mosaic tesserae, while at least a second is able to hold the glue and to be removed when the first layer comes into contact with the suction drum, the device according to the invention also comprises a winding roller, arranged substantially parallel to the suction drum and able to rewind the second layer after it has been detached from said first layer.

According to another variant, the device includes means able to perform a heating action on the surface of the tesserae before the application of the supporting sheet, in order to remove and eliminate any possible formation of condensation which might reduce the efficacy of the adhesion of the sheet and, at a later time, cause localized detachments and bulges.

In a first embodiment, said heating action is performed by means of a bar which delivers a flow of hot air. According to a variant, a radiating device is used, for example of the type with microwaves, or any other type of heating element.

In a preferential embodiment, also according to the environmental conditions of temperature and humidity where the application is performed, said heating is carried out at a temperature of between about 20 and about 40° C.

### BRIEF DESCRIPTION OF THE DRAWINGS

These and other characteristics of the invention will become clear from the following description of the preferential form of embodiment, given as a non-restrictive example, with reference to the attached drawings wherein:

FIG. 1 is a side view of the device according to the invention;

FIG. 2 is a plane view of the device in FIG. 1;

FIG. 3 is a side view of a variant of the device in FIG. 1.

### DETAILED DESCRIPTION OF PREFERRED EMBODIMENT

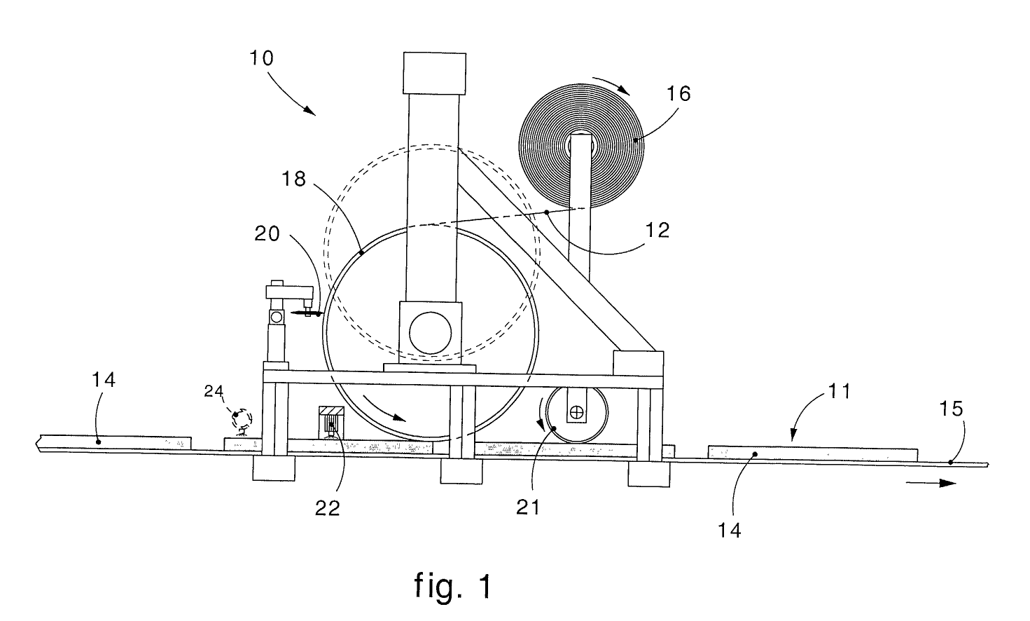

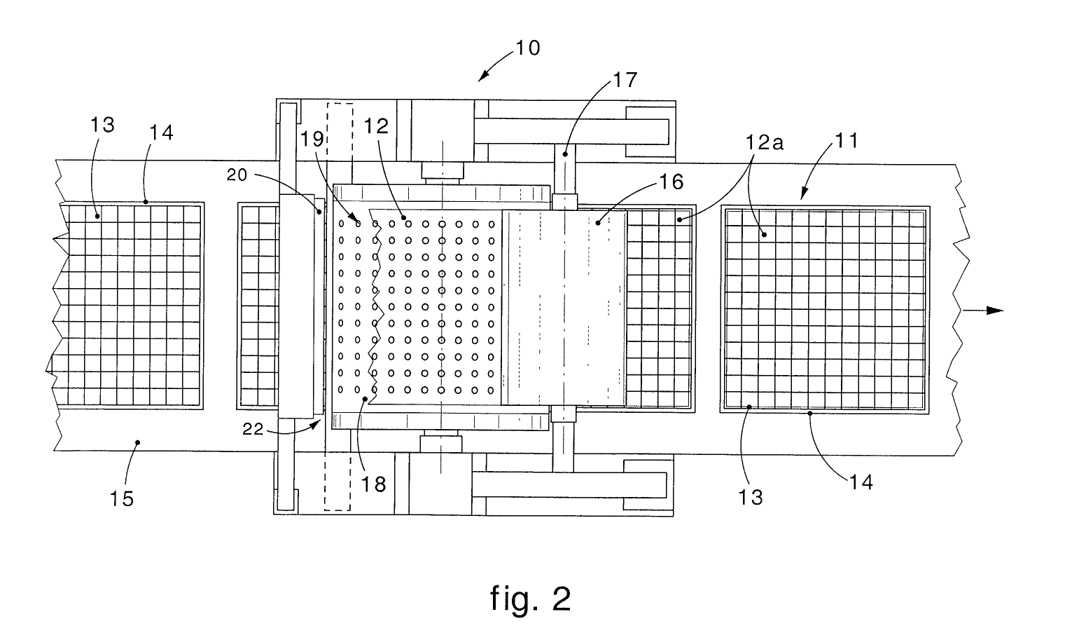

With reference to FIGS. 1 and 2, a device to produce panels 11 of glass mosaics is denoted in its entirety by the reference number 10.

The device 10 is used to apply a segment 12a of sheet 12 which can act either as a support or a lining, when cut to size, on a plurality of glass mosaic tesserae 13 housed inside a frame 14 which advances in linear fashion on a conveyor belt 15.

The face of the sheet 12 on which the tesserae 13 are applied is already adhesive.

In a first embodiment, as shown in FIGS. 1 and 2, the sheet 12 is made of transparent material, such as polyester, polyvinyl chloride (PVC), or other material with similar characteristics.

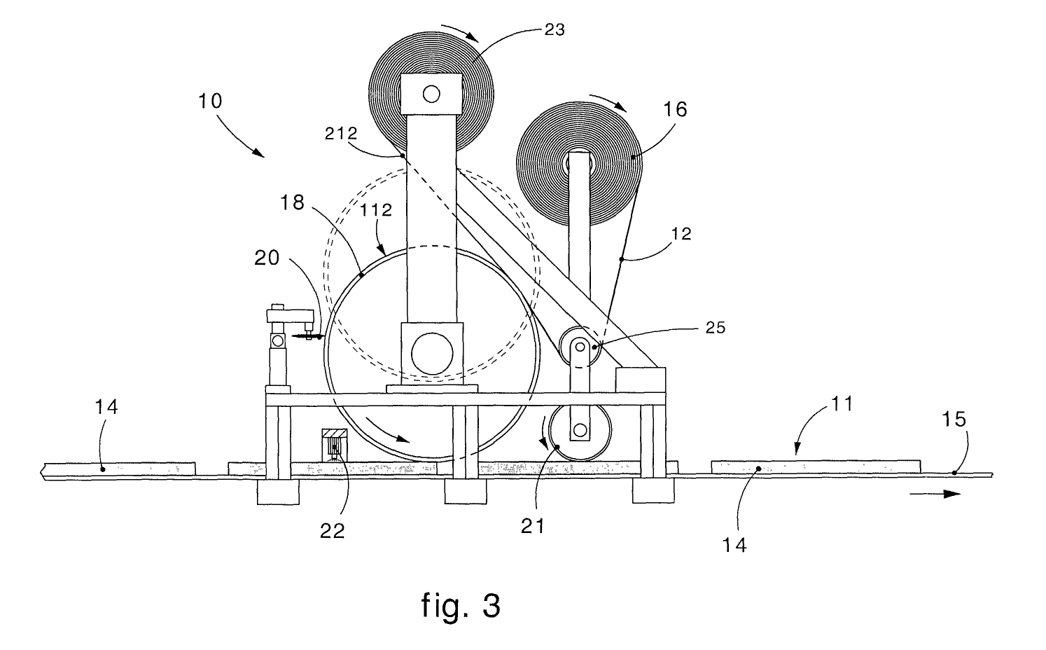

According to a variant, as shown in FIG. 3, the sheet 12 is made of paper.

The sheet 12 is fed, in this case, from a reel 16 mounted on a supporting shaft 17 which can be idle or associated with rotation means.

From the reel 16 the sheet 12 is wound with its non-adhesive face onto a hollow drum 18.

The drum 18 is equipped inside with means (not shown) able to create a depression and, on its cylindrical surface, with a plurality of holes 19 which create a suction from inside to outside against the surface of the drum 18.

Downstream of the first zone of contact between the sheet 12 and the drum 18 there are cutting means 20 able to cut the sheet 12 to size, creating a segment 12a correlated to the size of the frame 14 inside which the tesserae 13 are contained.

To be more exact, the sheet 12 is cut to a size such that it does not completely cover the panel or tile of mosaic tesserae 13, leaving free an edge of a few millimetres in correspondence with the perimeter, to keep the gaps between one tile and the adjacent ones exposed.

The segment 12a of the sheet 12, after it has been cut, stays attached to the outer surface of the drum 18 due to the suction exerted through the holes 19.

The segment 12a of the sheet 12 remains clamped against the cylindrical surface of the suction drum 18 and rotates at least through an angle such as to determine an inversion of direction, and hence its glued face is positioned facing downwards, that is to say, towards the frame 14 with the tesserae 13.

When the segment 12a is exactly facing the frame 14, since the rotation movements of the drum 18 and the conveyor belt 15 are synchronized, the suction of the drum 18 is locally interrupted and the segment 12a rests on the surface of the tesserae 13 facing upwards.

The systems to interrupt the suction of the drum 18 when the sheet 12 is released can be chosen from among conventional systems and are not therefore shown in the drawings.

For example, a first solution can provide mechanical means consisting of a fixed sector arranged inside the drum 18 for a zone correlated to the size of the frame 14 containing the tesserae 13.

Another solution can provide that the means able to create suction are distributed substantially over the entire circumference of the drum 18 and some of them can be selectively de-activated, and then immediately re-activated, according to commands given by position sensors which monitor the position of the sheet 12 with respect to the frame 14.

During the step when the sheet 12 is applied, while the sheet 12 is being released or immediately afterwards, the suction drum 18 is raised in order to release the interference and allow the frame 14 to pass.

Downstream of the suction drum 18 there is a pressure roller 21, the function of which is to press the segment 12a of the sheet 12 against the surface of the tesserae 13, to render the coupling stable.

In the event that the sheet 12 consists of paper, the device 10 also comprises a plurality of nozzles 22, arranged above the conveyor belt 15, near the drum 18, and able to spray the surface of the tesserae 13 with steam or nebulized water, to facilitate the adherence of the adhesive on the sheet 12 to the mosaic tesserae 13.

In the solution shown with a line of dashes in FIG. 1, in a desired position upstream of the zone where the sheet 12 is applied on the frame 14 there is a bar 24 able to selectively deliver a flow of hot air, for example at a temperature of between 20 and 40° C., in order to remove any possible formation of condensation from the surface of the tesserae 13.

This heating can, for example, be actuated in the presence of particular environmental conditions, for example in winter periods, when it is possible to have the formation of drops of condensation on the face of the tesserae 13 to which the sheet 12 is to be applied; this condensation can prejudice the efficacy of the adhesion of the sheet 12.

It is clear that instead of the bar delivering hot air 24 any other heating system can be provided, for example a radiating system with microwaves, infra-red rays or the like.

By using transparent sheets 12 to support or line the tesserae 13, it is possible to control the quality thereof at any moment, and to lay them more easily, since their visible face is not hidden by the sheet 12 positioned above them.

In this way, during the laying step, it is easier for the worker to perform the operations of adjustment and alignment because he can see the arrangement of the tesserae through the transparent film and correct any possible imprecisions.

Since the tesserae have a free face in contact with the surface to which they are to be applied, it is also possible to adapt the panel or the tesserae 13 to possible shapings or irregularities on said surface.

With reference to FIG. 3, in the event that the sheet 12 to be applied comprises at least two layers 112 and 212, of which the first layer 112 is able to be arranged on the mosaic tesserae 13, while the second layer 212 is able to hold the glue and be removed when the first layer 112 comes into contact with the suction drum 18, the device according to the invention also comprises a winding roller 23, arranged substantially parallel to the suction drum 18 and able to rewind said second layer 212 after it has been detached from the first layer 112.

In this case a return roller 25 is positioned between the reel 16 and the suction drum 18.

It is obvious that modifications or additions may be made to the device described heretofore, without departing from the spirit and scope of the invention.

It is also obvious that, although the invention has been described with reference to some specific examples, a skilled person shall certainly be able to achieve many other equivalent forms of device to produce mosaic panels, all of which shall come within the field and scope of this invention.

1 - Device to produce panels of mosaic tesserae (13), used to apply at least a supporting and/or lining sheet (12) on a visible face of said tesserae (13) arranged inside an advancing frame (14), said device comprising feeding means (16) and application means for applying said sheet (12) cooperating with the feeding means of said frame (14), characterized in that said application means comprise cutting means (20) able to cut to size a segment (12a) of said sheet (12) and suction drum rotating means (18) able to retain at least temporarily, on their outer cylindrical surface, said segment (12a) of sheet (12) and to release it onto said mosaic tesserae (13).

2 - Device as in claim 1, characterized in that said cutting means (20) are able to act on said sheet (12) when it is held on the outer surface of said suction drum means (18).

3 - Device as in claim 1 or 2, wherein said sheet (12) has a face equipped with gluing means, characterized in that said sheet (12) is able to wind on said suction drum means (18) with its face without gluing means and for an angle such as to invert the direction of feed and present its face equipped with gluing means facing towards said frame (14).

4 - Device as in any claim hereinbefore, characterized in that it comprises at least a pressure roller (21) arranged downstream of said suction drum means (18), said pressure roller (21) being able to press the segment (12a) of said sheet (12) against the surface of said tesserae (13) to achieve the stable attachment thereof.

5 - Device as in claim 1, characterized in that said suction drum means (18) comprise a hollow drum equipped inside with means able to create a depression and with a plurality of holes (19) on its cylindrical outer surface.

6 - Device as in claim 5, characterized in that said suction drum means (18) comprise means able to interrupt the suction at least in the step when the segment (12a) of said sheet (12) is released in correspondence with a relative frame (14) containing said tesserae (13).

7 - Device as in claim 6, characterized in that said means able to interrupt the suction comprise mechanical means arranged inside said hollow drum (18) for a zone correlated substantially to the size of said frame (14).

8 - Device as in claim 3, characterized in that it comprises means (22) to deliver steam or nebulized water arranged in cooperation with the visible face of said mosaic tesserae (13) and able to deliver a jet against said face to reactivate the glue on said sheet (12).

9 - Device as in any claim hereinbefore, characterized in that said suction drum means (18) are equipped with an alternate lifting/lowering movement to allow the free transit of the frame (14) after the segment of sheet (12) has been released.

10 - Device as in any claim hereinbefore, characterized in that it is able to apply said supporting and/or lining sheet (12) on the visible face of said tesserae (13).

11 - Device as in any claim from 3 to 10 inclusive, characterized in that, in the event that said sheet (12) to be applied comprises at least two layers (112 and 212), of which a first layer (112) is able to be arranged on said mosaic tesserae (13) and at least a second layer (212) is able to hold the glue and to be removed when said first layer (112) comes into contact with said suction drum (18), a winding roller (23) is arranged substantially parallel to said suction drum (18) to rewind said second layer (212) after it has been detached from said first layer (112).

12 - Device as in any claim hereinbefore, characterized in that it comprises means (24) able to heat the visible face of said tesserae (13) arranged upstream of said means to apply said sheet (12).

13 - Device as in claim 12, characterized in that said means able to heat the visible face of said tesserae (13) comprise at least a bar (24) delivering a flow of hot air.

14 - Device as in claim 12, characterized in that said means able to heat the visible face of said tesserae (13) comprise at least a radiating heating device.

15 - Method to produce panels of mosaic tesserae (13) and in particular to apply at least a supporting and/or lining sheet (12) on a visible face of the mosaic tesserae (13) arranged inside an advancing frame (14), the method using feeding means (16) and application means for applying said sheet (12) cooperating with the feeding means of said frame (14), characterized in that it provides that cutting means (20) cut to size a segment (12a) of the sheet (12) and that suction drum rotating means (18) retain at least temporarily, on their outer cylindrical surface, said segment (12a) of sheet (12) and release it onto said frame (14) containing said mosaic tesserae (13).

16 - Method as in claim 15, wherein said sheet (12) has a face equipped with gluing means, characterized in that it provides that said sheet (12) winds on said suction drum means (18) with its face without gluing means and for an angle such as to invert the direction of feed and to present its face equipped with gluing means facing towards said frame (14).

17 - Method as in claim 15 or 16, characterized in that it provides that at least a pressure roller (21), arranged downstream of said suction drum means (18), presses the segment of sheet (12) against the surface of said tesserae (13) to achieve the stable attachment thereof.

18 - Method as in any claim from 15 to 17 inclusive, characterized in that it provides to interrupt the suction of said suction drum means (18) at least in the step when the segment of sheet (12) is released in correspondence with a relative frame (14) containing said tesserae (13).

19 - Method as in any claim from 15 to 18 inclusive, characterized in that means (22) to deliver steam or nebulized water, arranged in cooperation with the visible face of said mosaic tesserae (13), deliver a jet against said visible face to re-activate the glue arranged on said sheet (12).

20 - Method as in any claim from 15 to 19 inclusive, characterized in that it provides to move said suction drum means (18) alternately up and down to allow the free transit of the frame (14) after the segment (12a) of sheet (12) has been released.

21 - Method as in any claim from 15 to 20 inclusive, characterized in that it provides to apply said supporting and/or lining sheet (12) onto the visible face of said tesserae (13).

22 - Method as in any claim from 15 to 21 inclusive, characterized in that heating means (24) deliver a heating flow onto the visible surface of said tesserae (13) before the sheet (12) is applied thereon.

23 - Method as in claim 22, characterized in that said heating flow has a temperature of between about 20 and about 40° C.

24 - Panels of glass mosaic, comprising a plurality of mosaic tesserae (13) arranged in a desired geometric configuration, characterized in that they comprise a transparent supporting sheet (12) arranged on the visible face of said mosaic tesserae (13).

25 - Panels as in claim 24, characterized in that said supporting sheet (12) has at least a face equipped with gluing means before it is applied onto said mosaic tesserae (13).
